(19) United States
(12) Patent Application Publication
(10) Pub. No.: US 2026/0022603 A1
(43) Pub. Date: Jan. 22, 2026

(54) ARRANGEMENT HAVING A STRUCTURE, A COVER ELEMENT AND A GUIDE SYSTEM

(71) Applicant: Julius Blum GmbH, Hoechst (AT)

(72) Inventors: Florian FISCHER, Hoechst (AT); Gerhard KLEINSASSER, Dornbirn (AT); Hermann HAEMMERLE, Lustenau (AT); Matthias REISSIG, Lindau (DE); Alexander Simon FLOGAUS, Eriskirch (DE)

(21) Appl. No.: 19/341,506

(22) Filed: Sep. 26, 2025

Related U.S. Application Data
(63) Continuation of application No. PCT/AT2024/060126, filed on Apr. 10, 2024.

(30) Foreign Application Priority Data
Apr. 12, 2023 (AT) A 50263/2023

(51) Int. Cl. E05D 15/56

(52) U.S. Cl. CPC E05D 15/56; E05Y 2201/626; E05Y 2201/64; E05Y 2201/684; E05Y 2900/132; E05Y 2900/148; E05Y 2900/20

(57) ABSTRACT

An arrangement includes a fixed structure, a cover element, and a guide system for guiding a movement of the cover element relative to the fixed structure. The guide system includes a first guide rail fastened to the fixed structure, preferably a pole thereof, and a second guide rail fastened to a cover element and movable relative to the first guide rail. The second guide rail is to be arranged in a recessed manner in the cover element, and the first guide rail is to be arranged in a recessed manner, preferably in the pole, in the fixed structure.

The present application is a continuation of International Application PCT/AT2024/060126 filed on Apr. 10, 2024. Thus, all of the subject matter of International Application PCT/AT2024/060126 is incorporated herein by reference.

### BACKGROUND OF THE INVENTION

The present invention relates to an arrangement with a guide system.

Such arrangements are generally used to move a covering element, such as a window, a door, or a drawer front, relative to a fixed structure, such as a building wall or a furniture body.

In particular, in the case of windows or doors, the movement comprises a lateral displacement of the covering element relative to the fixed structure. Such sliding windows or doors, which in particular allow the fixed structure to be opened completely, are also known, for example, from car sliding doors. In such solutions, the guide systems that allow the relative displacement between a cover element and the fixed structure are usually located on an outside of the structure, e.g., the car or building, since the cover element would only interfere with the interior of the structure when open.

The disadvantage here is that at least parts of the guide system are often permanently visible from the outside, protrude in a disruptive manner, and are unfavorably exposed to environmental influences. As a result, the guide system is increasingly exposed to mechanical stress, e.g., due to accidental impact or snagging, and to weather conditions, in particular moisture, frost, thermal deformation, etc., which in turn can lead to increased wear or functional problems.

### SUMMARY OF THE INVENTION

The task of the present invention is therefore to provide an arrangement with a guide system, in which the guide system is protected against any external influences, in particular in a closed position of the cover element.

This task is solved by an arrangement with a fixed structure, at least one cover element, and at least one guide system for guiding a movement of the cover element relative to the fixed structure. The guide system comprises a first guide rail fixed or fixable to the fixed structure, preferably to a frame, and at least one second guide rail fastened or fastenable to the at least one cover element, which is movable relative to the first guide rail. The second guide rail is recessed in the cover element and the first guide rail is recessed, preferably in the frame, in the fixed structure or can be arranged therein.

A first major advantage of the invention is that the guide system is protected by other components of the arrangement and is therefore hardly exposed to external influences. On the one hand, the guide system is significantly less exposed to weather conditions, in particular snow, moisture, or extreme temperatures; on the other hand, it is protected against unwanted impacts or snagging. As a result, functionality and maintenance intervals can be significantly extended.

In connection with accidental collisions or snagging, a reduced risk of injury to operators or passers-by can also be seen as an advantage.

Another advantage is that the recessed arrangement of the guide system allows for a visually and functionally minimalist design, meaning that the proposed guide system can serve as a technical basis for a range of applications in building construction. For example, the guide system can be used for windows, doors, blind, partition, and/or facade elements.

A covering element is not necessarily an element intended to cover an opening or another element, but may also have a shielding, separating, protective, or similar function.

The cover element can have any shape, design or construction, i.e. it can be solid, lattice-like, completely or partially flat, with or without a frame and/or have any material properties and/or surface characteristics.

In a particularly preferred embodiment, the covering element is a window and/or a door, which is intended for a window and/or door opening of a building.

In principle, the arrangement can comprise one or more fixed structures, cover elements, and/or guide systems.

It is particularly preferable that the guide system is arranged in a closed position of the cover element, recessed in the fixed structure and in the cover element, in particular so that the guide system is substantially completely enclosed by the fixed structure and the cover element.

It may also be that the guide system is arranged in a frame inserted into and/or fixed to the fixed structure and/or enclosed by the frame.

Preferably, the guide system is invisible from the outside when the cover element is in the closed position and/or concealed by the cover element and/or the frame and/or the fixed structure.

It is preferable that the first guide rail and the second guide rail, in the closed position and/or the suspended open position of the cover element, lie essentially congruent with one another in a view orthogonal to the cover element, preferably orthogonal to a central plane of the cover element. This is particularly advantageous if the cover element is a window or a door and the fixed structure is a building.

In the event that the cover element is a drawer front and the fixed structure is a furniture body, it is preferable that the first guide rail and the second guide rail lie essentially congruently on top of each other in the closed position of the cover element in a view parallel to the cover element.

It is particularly preferred that the guide system is designed to move the cover element between the closed position and a suspended open position that is essentially orthogonal, preferably outward, and/or a fully open position, in particular a laterally displaced open position, of the cover element, in particular wherein:
the closed position of the cover element corresponds to a first operating position of the guide system and/or
the suspended open position of the cover element corresponds to a second operating position of the guide system and/or
the fully open position of the cover element corresponds to a third operating position of the guide system.

The first guide rail and the second guide rail can be arranged essentially parallel to each other, in particular in the closed position and/or in the suspended open position and/or in the fully open position of the cover element.

The first guide rail and/or the second guide rail is or are preferably essentially C-shaped, but may also have any other shape.

Preferably, the guide system, in particular in a closed position of the cover element, is recessedly arranged (recessed) or can be recessedly arranged in the fixed structure and in the cover element, preferably by a casing and/or a frame, in such a way that the cover element is essentially flush with the surface of the fixed structure.

Preferably, the fixed structure, e.g. a furniture body or a building, has an opening, wherein the opening can be covered and/or closed by the covering element, e.g. a drawer front, a window or a door.

In preferred embodiments, the at least one, in particular essentially rectangular, cover element has two outer edges arranged essentially horizontally in an operating position, along each of which at least one guide system is arranged.

In particularly preferred embodiments, the first guide rail and the second guide rail are connected to each other such that they can be moved relative to each other by at least one articulated lever mechanism, preferably by at least two articulated lever mechanisms. In particular, the second guide rail is suspended on the first guide rail by the articulated lever mechanism. Preferably, the second guide rail and the first guide rail enclose an imaginary volume during a movement of the cover element, in particular between a closed position and a suspended open position and/or fully open position of the cover element, and the at least one articulated lever mechanism remains essentially within this volume and does not protrude in an unfavorable manner.

Preferably, the first guide rail and/or the second guide rail are each designed to support the at least one articulated lever mechanism, preferably by at least one running wheel, in particular as part of at least one running carriage and/or linearly, movably along a longitudinal axis of the first guide rail and/or the second guide rail.

The at least one articulated lever mechanism may comprise at least one running carriage, which allows relative displacement between the at least one articulated lever mechanism and/or parts of the articulated lever mechanism and the first guide rail and/or the second guide rail. The at least one running carriage is supported and/or guided vertically, preferably also horizontally and/or by means of rollers.

Preferably, the at least one articulated lever mechanism is mounted, preferably by at least one groove, in a rotatable, form-fitting manner and in a translatorily displaceable manner along a longitudinal axis of the first guide rail and/or the second guide rail, in particular during a movement of the cover element between a suspended open position and a fully open position.

Preferably, the guide system has at least two support levers connected to each other in an articulated manner via a first joint axis, which two support levers each form a support toggle lever, and at least two drive levers connected to each other in an articulated manner via a second joint axis, which two drive levers each form a drive toggle lever, preferably with the first joint axis and the second joint axis running essentially orthogonally to each other.

The guide system may have at least one synchronization device for synchronizing the movement of at least two drive toggle levers, preferably which synchronization device is arranged on the first guide rail and/or has at least one synchronization shaft and/or at least one cable pull.

### BRIEF DESCRIPTION OF THE DRAWINGS

Further advantages and details of the invention will be apparent from the following description with reference to the drawings, in which:

FIG. 1-3 show positions of an embodiment of an arrangement according to the invention,

FIG. 4 shows a position of an embodiment of an arrangement according to the invention,

FIG. 5 shows an example of a fixed structure,

FIG. 6 shows a position of the first arrangement embodiment in cross-section,

FIGS. 7-8 show a position of the first arrangement embodiment in cross-section and in detail,

FIGS. 9-14 show operating positions of an embodiment of a guide system, each in an overall and detailed view,

FIGS. 15-17 show positions of an embodiment of an articulated lever mechanism,

FIG. 18 is an exploded view of an articulated lever mechanism,

FIG. 19 is a detailed view of an articulated lever mechanism, and

FIGS. 20-25 show examples of cover element frame connections.

### DETAILED DESCRIPTION OF THE INVENTION

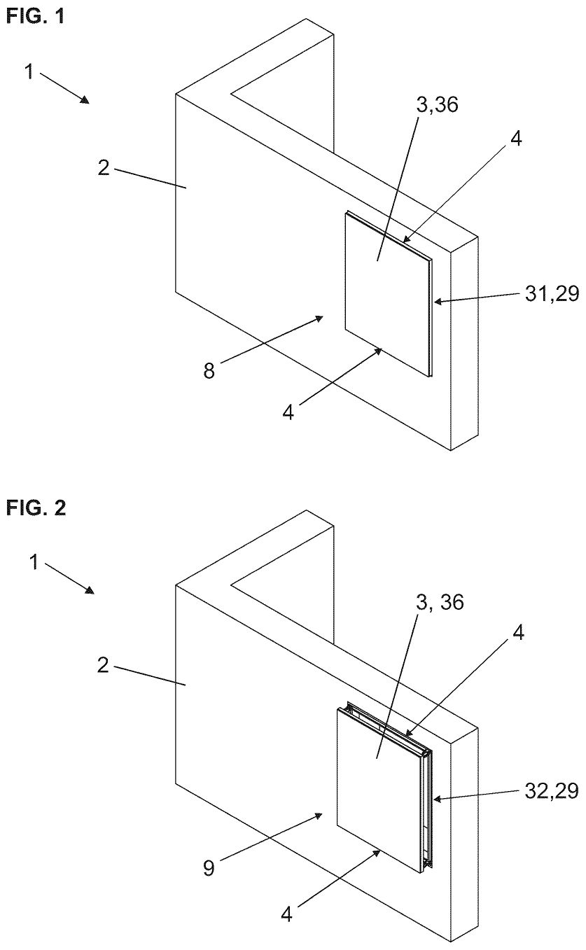

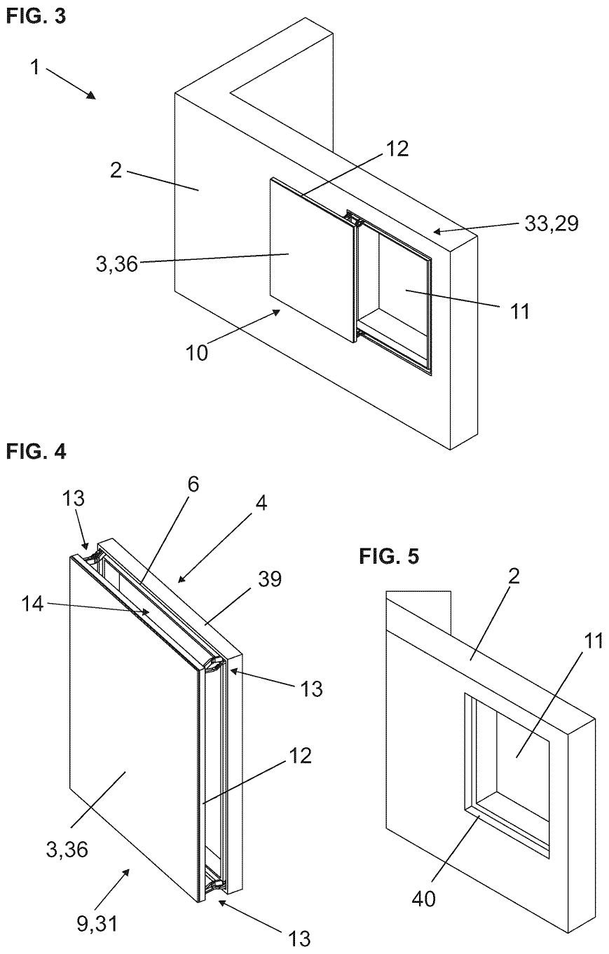

FIGS. 1-3 show positions of a preferred embodiment of an arrangement 1 according to the invention with a fixed structure 2 and a cover element 3, wherein the cover element 3, preferably comprising a pane 36, is in the closed position 8 in FIG. 1, in FIG. 2 in the suspended open position 9, and in FIG. 3 in the fully open position 10.

In this embodiment, arrangement 1 comprises two guide systems 4 for guiding the movement of the cover element 3 relative to the fixed structure 2, whereby the guide system 4 is shown in more detail in the following figures.

The operating positions 29 of the guide systems 4 correspond to the positions of the cover element 3, whereby the first operating position 31 of the guide system 4 corresponds to the closed position 8 (FIG. 1) of the cover element 3, the second operating position 32 corresponds to the suspended open position 9 (FIG. 2) and the third operating position 33 corresponds to the fully open position 10 of the cover element 3.

In the closed position 8 (FIG. 1) of the cover element 3, an opening 11 of the fixed structure 2 is closed and/or the outer edge 12 of the cover element 3, e.g., the window frame touches, essentially the frame 39, e.g., the window casing, preferably with the cover element 3 being essentially flush with the surface of the fixed structure 2.

In the suspended open position 9 (FIG. 2) of the cover element 3, the cover element 3 is in a position that is orthogonally offset from the closed position 8, in particular toward the outside.

In the fully open position 10 (FIG. 3), the cover element 3 is in a position that is shifted sideways relative to the suspended open position 9, so that any opening 11 is essentially completely or largely exposed.

FIG. 4 shows the same embodiment of an arrangement 1 according to the invention, in which the cover element 3, preferably comprising a pane 36, is in the suspended open position 9 and the guide systems 4 are correspondingly in the second operating position 31, wherein a articulated lever mechanism 13 is located at each of the corners of the cover element 3 and/or the frame 39.

FIG. 5 shows an example of a fixed structure 2 with an opening 11 with a reveal 40, into which, for example, the elements of the arrangement 1 shown in FIG. 4, in particular the frame 39 with all elements attached to it, can be inserted.

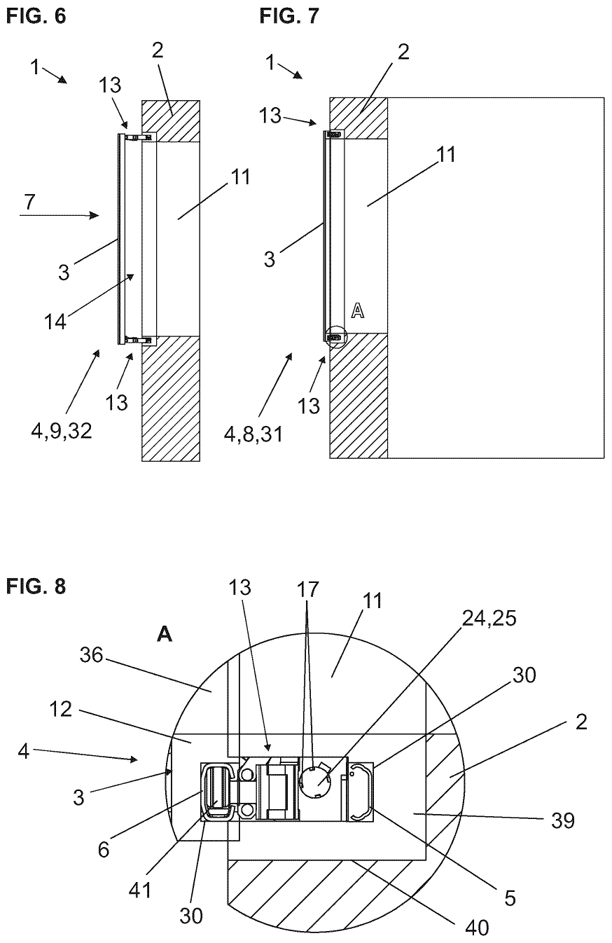

FIG. 6 shows a cross-section of the embodiment of the arrangement 1 shown in FIG. 2, wherein the cover element 3 is in the suspended open position 9 and the guide system 4 is correspondingly in the second operating position 32.

Here, view 7 is shown orthogonally to the cover element 3, in which view 7 the first guide rail 5 and the second guide rail 6 lie essentially congruent on top of each other in the closed position 8 and/or suspended open position 9 of the cover element 3. The first guide rail 5 and the second guide rail 6 are shown in more detail in the detailed section of FIG. 8.

FIGS. 7-8 show a section and a detailed section taken from it of the embodiment of arrangement 1 shown in FIG. 1 in the closed position 8 of the cover element 3, comprising at least one pane 36.

The detailed section in FIG. 8 shows the first guide rail, which is preferably attached or attachable to the frame 39 in the reveal of the fixed structure 2, and the at least one second guide rail 6, which is attached or attachable to the at least one cover element 3 and is movable relative to the first guide rail 5.

In the closed position 8, the second guide rail 6 is recessed in the cover element 3 and the first guide rail 5 is recessed, preferably in the frame 39, in the fixed structure 2, in particular with the guide system 4 being essentially completely enclosed by the fixed structure 2 and/or the frame 39 and the cover element 3.

In this embodiment, the first guide rail 5 and the second guide rail 6 are essentially C-shaped and arranged parallel to each other.

In this embodiment, the second guide rail 6 is arranged completely outside an installation space 30 of the first guide rail 5 in the closed position 8 and/or the suspended open position 9 and/or the fully open position 10, preferably in all three of these operating positions 29.

This detailed view also shows a running carriage 41 mounted so that it can slide in the second guide rail 6.

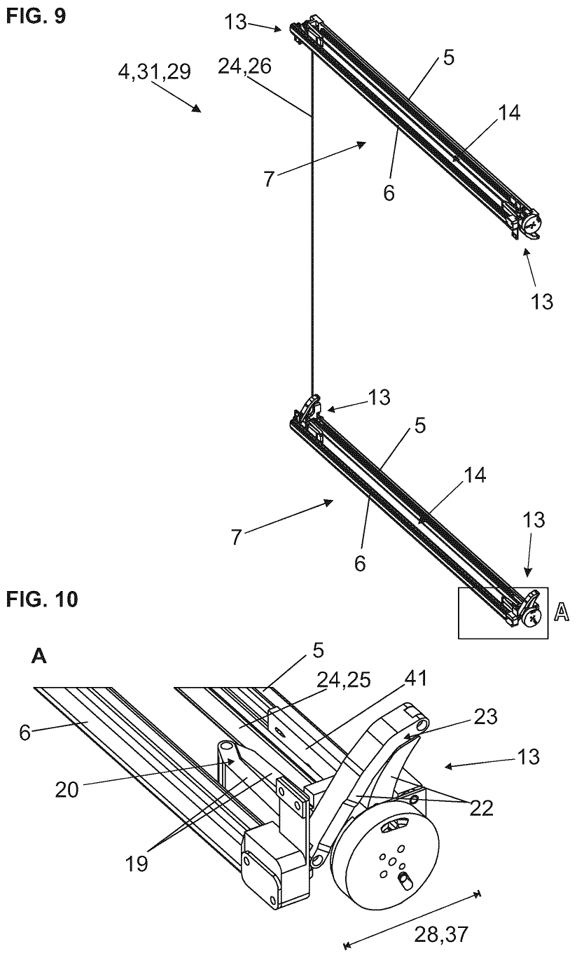

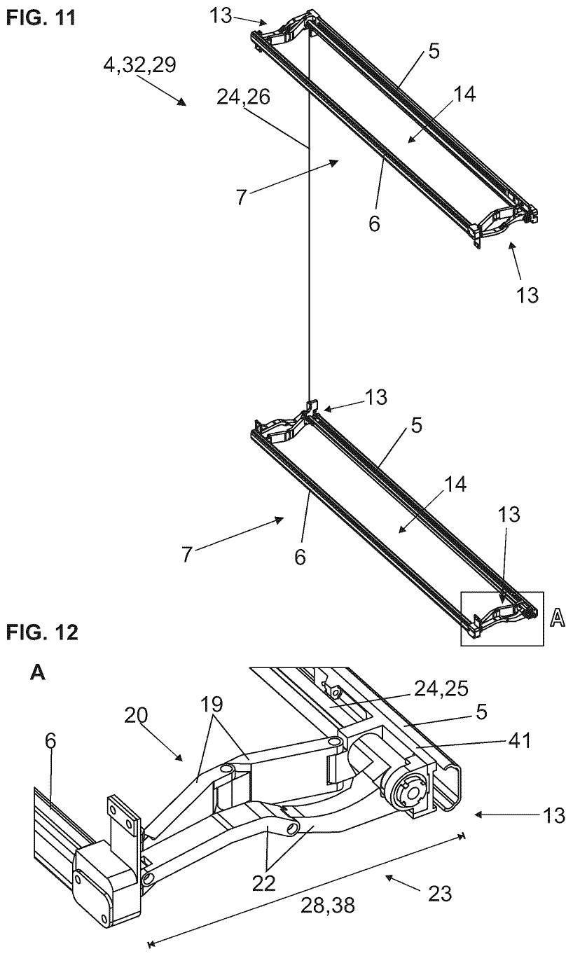

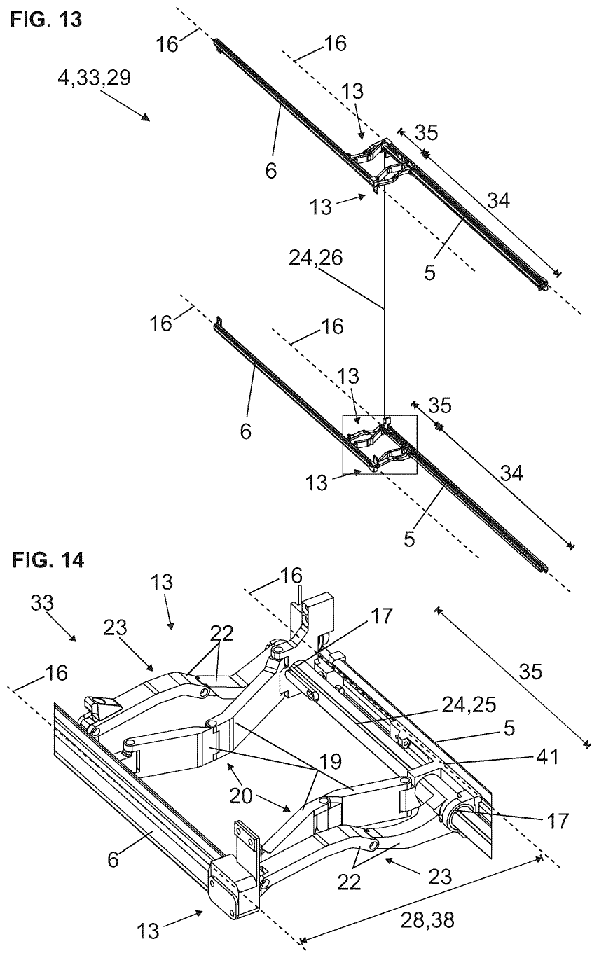

FIGS. 9-14 show operating positions 29 of the same design embodiment of the guide system 4, each in a general view (FIGS. 9, 11, 13) and a corresponding detailed view (FIGS. 10, 12, 14). FIGS. 9 and 10 show the guide system 4 in the first operating position 31; FIGS. 11 and 12 show it in the second operating position 32; and FIGS. 13 and 14 show it in the third operating position 33.

This guide system 4 comprises two first guide rails 5 and two second guide rails 6, wherein a first guide rail 5 and a second guide rail 6 are connected to each other in such a way that they can be moved relative to each other by means of two articulated lever mechanisms 13.

In this embodiment, the second guide rails 6 attached to the cover element 3 move relative to the first guide rails 5 attached to the fixed structure 2.

It can be imagined that the second guide rail 6 and the associated first guide rail 5 each span an imaginary volume 14 during a movement of the first guide rail 5 or the cover element 3 with the first guide rail 5, in particular between a closed position 8 and a suspended open position 9 and/or fully open position 10 of the cover element 3, with the at least one articulated lever mechanism 13 remaining essentially within this volume 14.

This embodiment of the guide system 4 comprises at least two support levers 19 connected to each other in an articulated manner via a first joint axis 18, wherein two support levers 19 each form a support toggle lever 20, and at least two drive levers 22 connected to each other in an articulated manner via a second joint axis 21, wherein two drive levers 22 each form a drive toggle lever 23, preferably wherein the first joint axis 18 and the second joint axis 21 run essentially orthogonally to each other.

This embodiment of guide system 4 comprises at least one synchronization device 24 for synchronizing the movement of at least two drive toggle levers 23, preferably which synchronization device 24 is arranged on the first guide rail 5 and/or has at least one synchronization shaft 25 and/or has at least one cable pull 26.

FIGS. 10, 12, and 14 in particular show that the first guide rail 5 and the second guide rail 6 are preferably further apart from each other in the suspended open position 9 (FIG. 12) and/or the fully open position 10 (FIG. 14) of the cover element 3 than in the closed position 8 (FIG. 10), preferably with the first guide rail 5 and the second guide rail 6 having a distance 28 and/or maximum distance 38 of between 50 mm and 200 mm in the suspended open position 9 and/or the fully open position 10 of the cover element 3, particularly preferably a distance 28 and/or maximum distance 38 of between 100 mm and 150 mm.

In the closed position 31 of the cover element 3, the distance 28 is preferably a minimum distance 37 (FIG. 10).

The distance 28 between the first guide rail 5 and the second guide rail 6 can be changed, in particular by moving the second guide rail 5 and/or the cover element 3 to which the second guide rail is attached.

In particular, FIGS. 13 and 14 show that the first guide rail 5 and/or the second guide rail 6 are preferably each designed to support the at least one articulated lever mechanism 13, preferably by means of at least one running carriage 41, in particular comprising at least one running wheel 15, to be guided in a displaceable manner along a longitudinal axis 16 of the first guide rail 5 and/or the second guide rail 6.

It is shown here that the at least one articulated lever mechanism 13 is preferably mounted by means of at least one groove 17, rotationally positive locking and translatorily displaceable along the first guide rail 5 and/or the second guide rail 6.

The guide system 4 is preferably designed to guide the cover element 3 by means of at least four support toggle levers 23, in particular whereby two of the four support toggle levers 23 are spaced apart from each other at a minimum support lever distance along the longitudinal direction 16 of the first guide rail 5 and/or the second guide rail 6, in particular in the fully open position 10 of the cover element 3 and/or the third operating position 33 of the guide system 4, free-standing, see FIGS. 13 and 14.

In the third operating position 33 of the guide system 4, the first guide rail 5 and the second guide rail 6 are preferably spaced apart from each other in a longitudinal direction 16 of the first guide rail 5 and/or the second guide rail 6 by a maximum longitudinal distance 34, i.e., in particular, the first guide rail 5 and the second guide rail 6 are aligned parallel to each other in the longitudinal direction 16.

The operating positions 29 shown in FIGS. 9-14 are preferably achieved by a method for moving the cover element 3 relative to the fixed structure 2 by means of the guide system 4, wherein the at least one cover element 3 is moved between at least two operating positions 29, in particular wherein the distance 28 is variable and/or is changed.

To open the cover element 3 from the closed position 8, in which the distance 28 is preferably a minimum distance 37:
the cover element 3 is moved to an orthogonally suspended open position 9, in which the distance 28 is preferably the maximum distance 38, and/or
the cover element 3 is moved into a fully open position 10, in which the distance 28 is preferably the maximum distance 38.

To close the cover element 3, the cover element 3 is moved into the closed position 8 starting from the fully open position 10 and/or the orthogonally suspended open position 9.

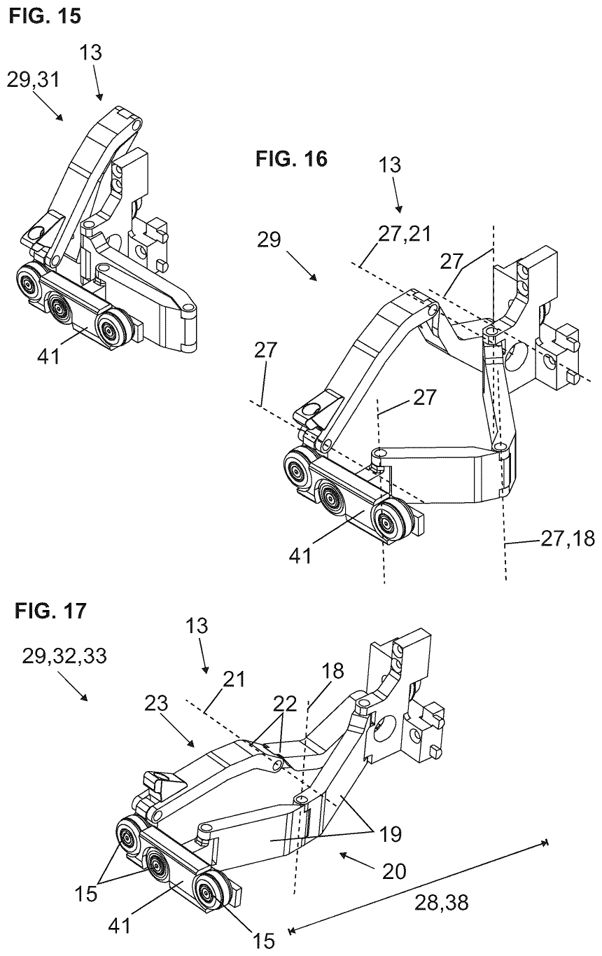

FIGS. 15-17 show positions of a particularly preferred embodiment of an articulated lever mechanism 13, wherein FIG. 15 corresponds to the first operating position 31, FIG. 16 to an intermediate position, and FIG. 17 to the second operating position 32 and/or the third operating position 33 of the guide system 4.

It is shown here that the guide system 4, in particular the articulated lever mechanism 13, has at least two support levers 19 connected to each other in an articulated manner via a first joint axis 18, which two support levers 19 each form a support toggle lever 20, and at least two drive levers 22 connected to each other in an articulated manner via a second joint axis 21, which two drive levers 22 each form a drive toggle lever 23, preferably with the first joint axis 18 and the second joint axis 21 running essentially orthogonally to each other.

It is preferable that the articulated lever mechanism 13 has more than four, preferably exactly six, joint axes 27, and/or has at least one, preferably more than one, support lever 19 and/or drive lever 22, which is curved and/or angled in some areas.

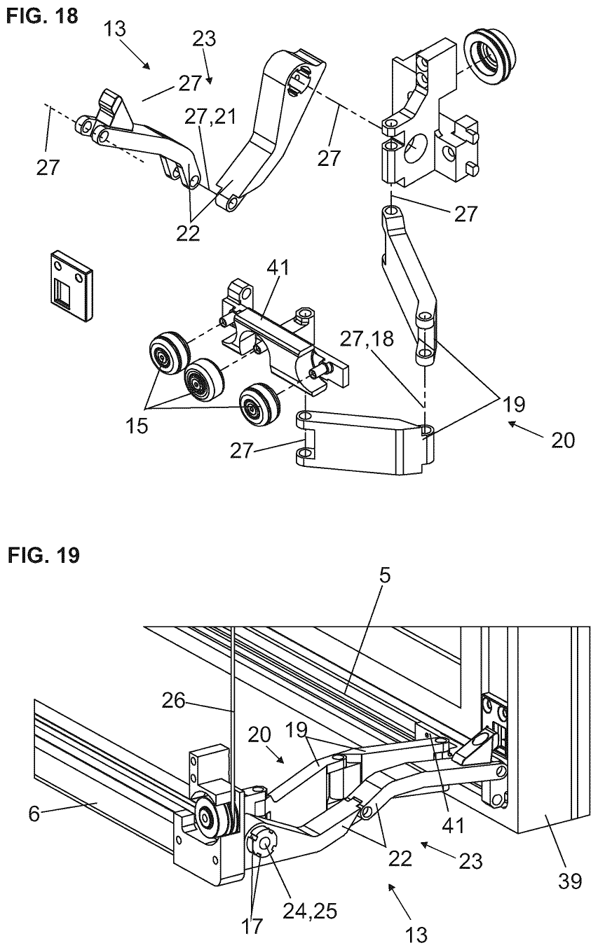

FIG. 18 shows an exploded view of the articulated lever mechanism 13 shown in the preceding figures. FIG. 19 shows a detailed view of the same articulated lever mechanism 13, which connects the first guide rail 5 inserted into the frame 39 and the second guide rail 6, supports the guide rail 6 and/or enables movement of the second guide rail 6 relative to the first guide rail 5.

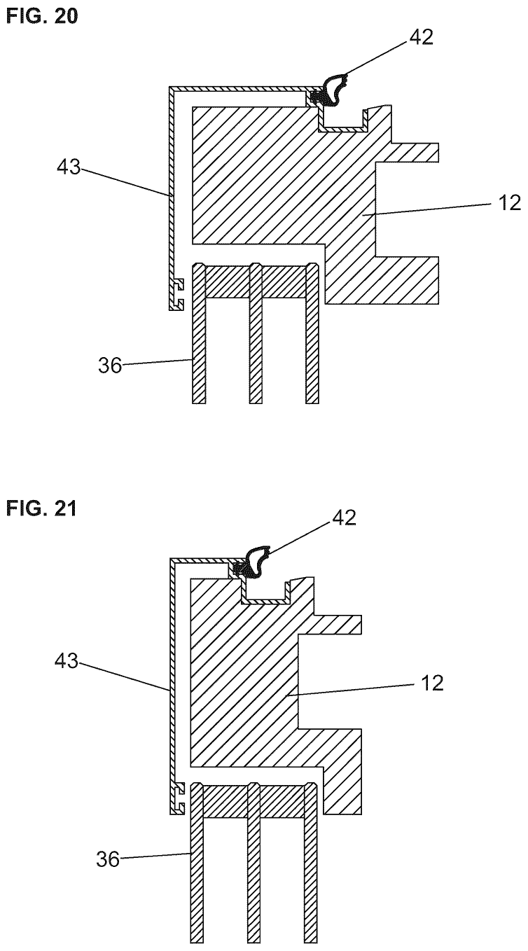

FIGS. 20-25 show details of examples of connections, preferably window or door frame connections, for panes 36, in particular window or door panes, of cover elements 3 for fastening the panes 36 to the outer edges 12 of the cover element 3, wherein the outer edges 12 are designed in particular as frames.

The respective connections comprise at least an outer edge 12 or frame, a pane 36, a seal 42, and a seal receptacle 43.

FIGS. 20 and 21 show embodiments of a connection, whereby in each case the outer edge 12 is a wooden frame, the seal holder is an aluminum part, and the pane 36 is a multi-pane insulating glass.

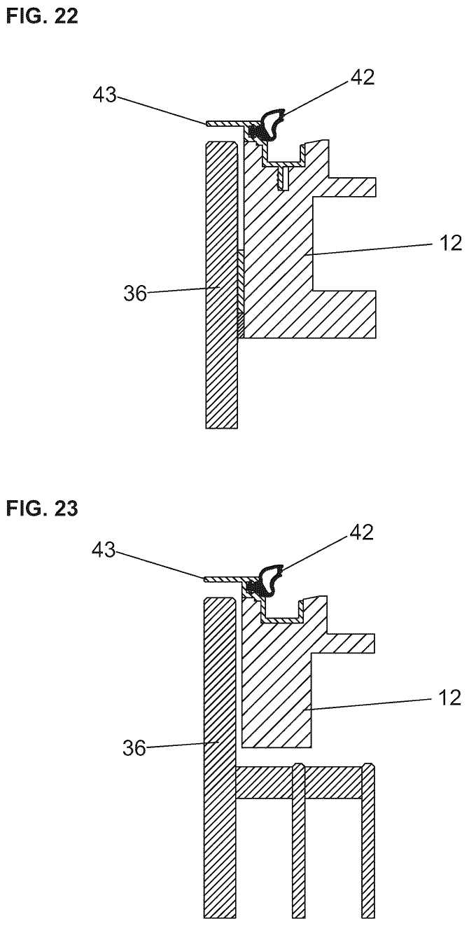

FIG. 22 shows an embodiment of a connection, wherein the outer edge 12 is a wooden frame, the seal holder is an aluminum part, and the pane 36 is vacuum insulating glass.

FIG. 23 shows an embodiment of a connection, whereby the outer edge 12 is a wooden frame, the seal holder is an aluminum part, and the pane 36 is stepped-bevel glass. FIG. 24 shows an embodiment of a connection, wherein the outer edge 12 is an aluminum frame, the seal holder is an aluminum part, and the pane 36 is vacuum insulating glass.

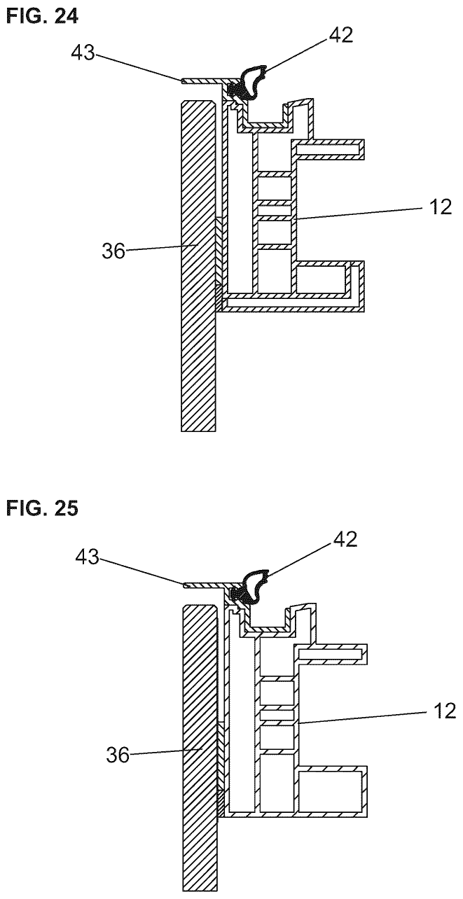

FIG. 25 shows an embodiment of a connection in which the outer edge 12 is an aluminum frame, the seal holder is a plastic part, and the pane 36 is vacuum insulating glass.

In principle, however, other designs of such connections are also conceivable.

1. An arrangement comprising:
a fixed structure,
at least one cover element, and
at least one guide system for guiding a movement of the cover element relative to the fixed structure,
wherein the guide system includes:
a first guide rail fixed or fixable to, preferably a frame, of the fixed structure, and
at least one second guide rail fixed or fixable to the at least one cover element, which is movable relative to the first guide rail,
wherein the second guide rail is recessed in the cover element and the first guide rail is recessed, preferably in the frame, in the fixed structure or can be arranged therein.

2. The arrangement according to claim 1, wherein the guide system is arranged in a closed position of the cover element recessed in the fixed structure and in the cover element, in particular so that the guide system is substantially completely enclosed by the fixed structure and/or the frame and the cover element.

3. The arrangement according to claim 2, wherein the first guide rail and the second guide rail lie substantially congruently on top of one another in the closed position and/or in an open position of the cover element which is essentially orthogonal, in a view orthogonal to the cover element.

4. The arrangement according to claim 3, wherein the guide system is designed to move the cover element between the closed position and the suspended open position and/or a fully open position of the cover element, in particular a laterally displaced fully open position.

5. The arrangement according to claim 1, wherein the first guide rail, which is preferably formed substantially C-shaped, and the second guide rail, which is preferably formed substantially C-shaped, are arranged substantially parallel to each other.

6. The arrangement according to claim 1, wherein the guide system, in particular in a closed position of the cover element, can be recessed in the cover element and, in particular by means of a frame, in the fixed structure in such a way that the cover element is essentially flush with the surface of the fixed structure.

7. The arrangement according to claim 1, wherein the fixed structure has at least one opening which can be covered by the at least one cover element.

8. The arrangement according to claim 1, wherein the at least one, in particular essentially rectangular, cover element has two essentially horizontal outer edges, along each of which at least one guide system is arranged.

9. The arrangement according to claim 1, wherein the first guide rail and the second guide rail are connected to each other such that they are movable relative to each other by at least one articulated lever mechanism, preferably by at least two articulated lever mechanisms.

10. The arrangement according to claim 9, wherein the second guide rail and the first guide rail during a movement of the cover element, in particular between a closed position and a suspended open position and/or a fully open position of the cover element, enclose an imaginary volume and wherein the at least one articulated lever mechanism remains essentially within this volume.

11. The arrangement according to claim 9, wherein the first guide rail and/or the second guide rail is/are each designed to guide the at least one articulated lever mechanism, preferably by at least one running carriage, in particular comprising at least one running wheel, displaceable along a longitudinal axis of the first guide rail and/or the second guide rail.

12. The arrangement according to claim 9, wherein the at least one articulated lever mechanism is mounted, preferably by at least groove, in a rotationally positive locking manner and translatorily displaceable along a longitudinal axis of the first guide rail and/or the second guide rail.

13. The arrangement according to claim 9, wherein the guide system includes:
at least two support levers connected to each other in an articulated manner via a first joint axis, wherein the at least two support levers each form a support toggle lever, and
at least two drive levers connected to each other in an articulated manner via a second joint axis, wherein the at least two drive levers each form a drive toggle lever, preferably wherein the first articulated axis and the second articulated axis run essentially orthogonally to each other, and/or
at least one synchronization device for synchronizing the movement of at least two drive toggle levers, preferably wherein the synchronization device is arranged on the first guide rail and/or has at least one synchronization shaft and/or at least one cable pull.

14. The arrangement according to claim 9, wherein the articulated lever mechanism has more than four, preferably exactly six, joint axes, and/or at least one, preferably more than one, support lever and/or drive lever, which is curved and/or angled in some areas.

15. The arrangement according to claim 3, wherein the first guide rail and the second guide rail are further apart from each other in the suspended open position and/or the fully open position than in the closed position, preferably wherein the first guide rail and the second guide rail in the suspended open position and/or the fully open position have a distance of between 50 mm and 200 mm, particularly preferably a distance of between 100 mm and 150 mm.

16. The arrangement according to claim 3, wherein the second guide rail is arranged completely outside an installation space of the first guide rail in the closed position and/or the suspended open position and/or the fully open position, preferably in all these three operating positions.

17. The arrangement according to claim 15, wherein the distance between the first guide rail and the second guide rail is variable.
